(19) United States
(12) Patent Application Publication
(10) Pub. No.: US 2026/0164274 A1
(43) Pub. Date: Jun. 11, 2026

(54) OPPORTUNISTICALLY REPORTING RECEIVE CHAIN MEASUREMENTS

(71) Applicant: QUALCOMM Incorporated, San Diego, CA (US)

(72) Inventors: Mukesh KUMAR, Hyderabad (IN); Guttorm Ringstad OPSHAUG, Redwood City, CA (US); Alexandros MANOLAKOS, Athens (GR)

(21) Appl. No.: 18/707,118

(22) PCT Filed: Nov. 22, 2022
(86) PCT No.: PCT/US2022/050786

§ 371 Date: May 2, 2024

(30) Foreign Application Priority Data
Jan. 20, 2022 (GR) 20220100049

(51) Int. Cl. H04W 24/10; H04B 17/309

(52) U.S. Cl. CPC H04W 24/10; H04B 17/346

(57) ABSTRACT

Method and apparatus to opportunistically reporting one or more additional receive chain measurements. The apparatus performs one or more measurements of positioning reference signals using each receive chain of a plurality of RX chains at a UE. The apparatus transmits a report including RX measurements associated with each receive chain of the plurality of receive chains at the UE. The apparatus indicates within the report that one or more additional RX paths are not present in the measurement of the positioning reference signals. The apparatus indicates within the report that one or more additional RX paths are present in the measurement of the positioning reference signals, wherein the one or more additional RX paths are indicated within a first field associated for reporting the one or more additional RX paths.

### CROSS-REFERENCE TO RELATED APPLICATION

This application claims the benefit of Greek patent application No. 20220100049, entitled “OPPORTUNISTICALLY REPORTING RECEIVE CHAIN MEASUREMENTS” and filed on Jan. 20, 2022, which is expressly incorporated by reference herein in its entirety.

### TECHNICAL FIELD

The present disclosure relates generally to communication systems, and more particularly, to techniques and protocols for opportunistically reporting receive chain measurements.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus may perform one or more measurements of downlink positioning reference signals using each receive chain of a plurality of receive (RX) chains at the UE. The apparatus may transmit a report including RX measurements associated with each receive chain of the plurality of the receive chains at the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating instructions for a measurement report.

FIG. 5 is a diagram illustrating instructions for a measurement report.

FIG. 6 is a diagram of a UE having a plurality of Rx antennas.

FIG. 7 is a diagram of additional paths detected by the UE.

FIG. 8 is a diagram of channel profiles across different Rx paths.

FIG. 9 is a diagram of time of arrival (TOA) variations across different Rx chains.

FIG. 10 is a call flow diagram of signaling between a UE and a base station.

FIG. 11 is a flowchart of a method of wireless communication.

FIG. 12 is a flowchart of a method of wireless communication.

FIG. 13 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

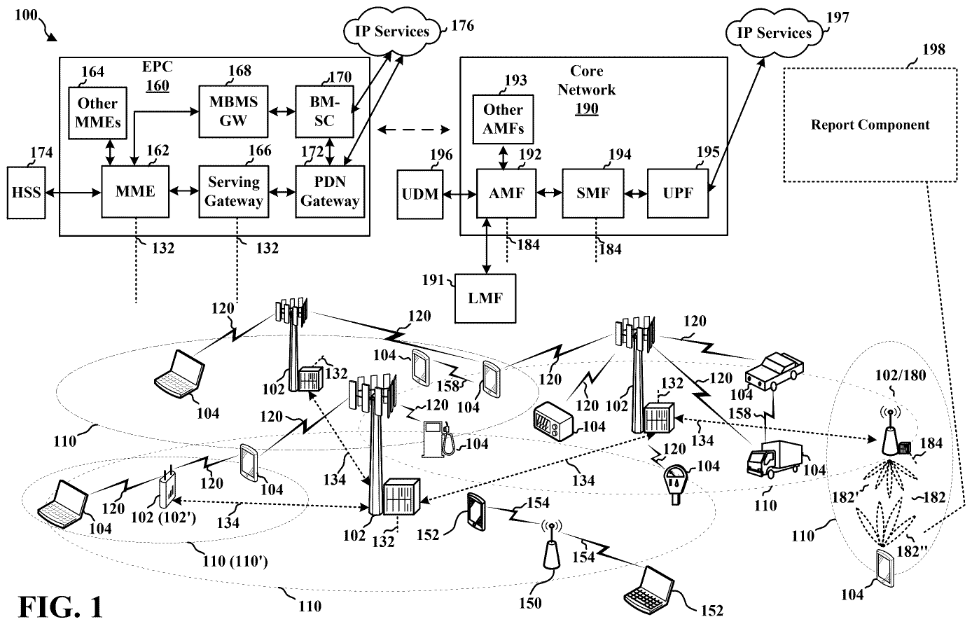

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services. In some instances, the core network 190 may communicate with a location server, such as a location management function (LMF) 191. The LMF may be utilized in positioning architecture. The LMF may receive measurements and assistance information from the NG-RAN and the UE 104 via the AMF 192. The LMF may utilize the measurements and assistance information to compute the position of the UE 104. The LMF may configure the UE via the AMF. The NG-RAN (e.g., base station 102/180) may configure the UE via RRC over LTE-Uu or NR-Uu.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to report multiple measurements across multiple RX chains. For example, the UE 104 may comprise a report component 198 configured to report multiple measurements across multiple RX chains. The UE 104 may perform one or more measurements of downlink positioning reference signals using each receive chain of the plurality of receive chains at the UE 104. The UE 104 may transmit a report including RX measurements associated with each receive chain of the plurality of the receive chains at the UE 104.

Although the following description may be focused on 5G NR, the concepts described herein may be applicable to other similar areas, such as LTE, LTE-A, CDMA, GSM, and other wireless technologies.

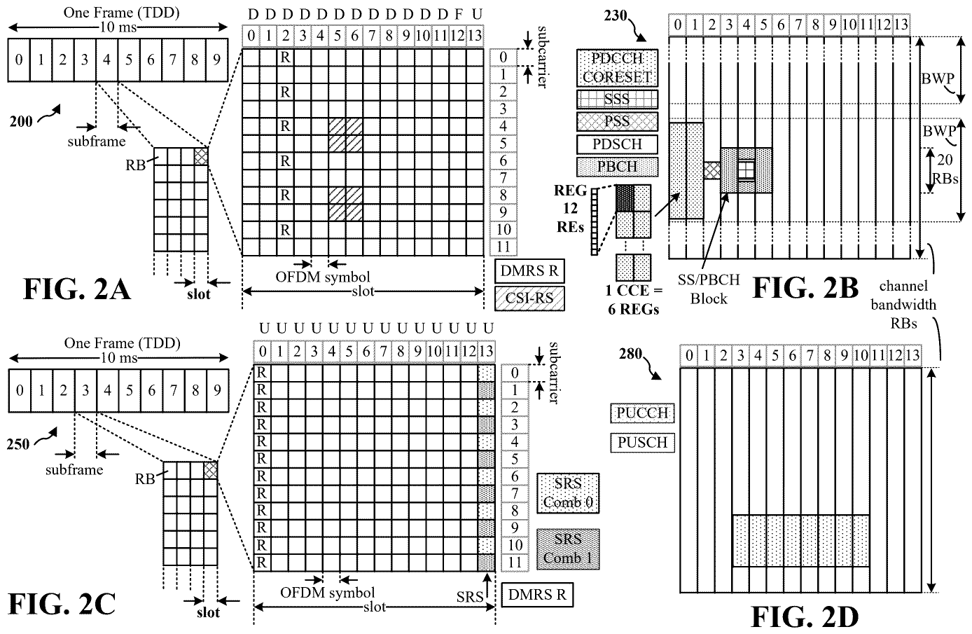

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

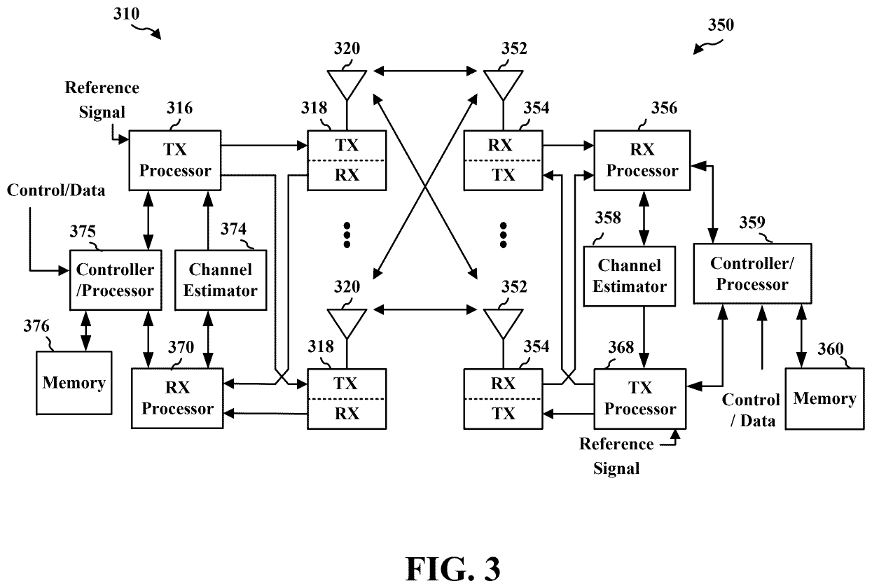

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

In wireless communication systems, such as 5G positioning systems, positioning measurements of a wireless device (e.g., UE) may allow for the position of the wireless device to be calculated. For example, downlink positioning reference signals are reference signals that supports downlink based positioning method. Positioning reference signals are defined for NR positioning to enable UEs to detect and measure positioning reference signals for location determination of the UE. Several configurations may be supported to enable a variety of deployments, such as but not limited to indoor applications, outdoor applications, sub-6 GHZ, or millimeter wave (mmW). Multiple position calculation methods (e.g., UE assisted or UE based) may be supported. For UE-assisted positioning, the UE performs measurements of the positioning reference signals (e.g., PRS) and provides the measurements to a location server (e.g., LMF) for the location server to determine or calculate the position of the UE. For UE-based positioning, the UE performs measurements of the positioning reference signals and calculates the position of the UE itself.

UEs may be configured to report the capability to process positioning reference signals in a capability indication. The UE may receive assistance data from the LMF via the base station to perform the positioning reference signals measurements. However, the measurements to be measured may exceed the capability of the UE In some instances, the assistance data may indicate X number of PRS resources to measure while the UE may be configured to only process up to Y number of PRS resources, where X>Y, such that the measurements to be measured included in the assistance data may exceed the capabilities of the UE. For example, the UE may be configured to process up to 5 positioning reference signals resources, while the positioning reference signals in the assistance data may comprise 20 positioning reference signals resources to measure. The UE may be configured to select the first 5 positioning reference signals for processing. When a UE is configured as indicated in the assistance data of a positioning method with a number of positioning reference signals resources beyond the capability of the UE, the UE may assume that the downlink positioning reference signals in the assistance data are sorted in a decreasing order of measurement priority. For example, the measurement priority may comprise that the frequency layers may be sorted according to priority, the number of TRPs per frequency layer may be sorted according to priority, 2 sets per TRP of the frequency layer may be sorted by priority, or the number of resources of the set per TRP per frequency layer may be sorted according to priority. The reference indicated by nr-DL-PRS-ReferenceInfo-r16 for each frequency layer may have the highest priority at least for downlink time difference of arrival (DL-TDOA).

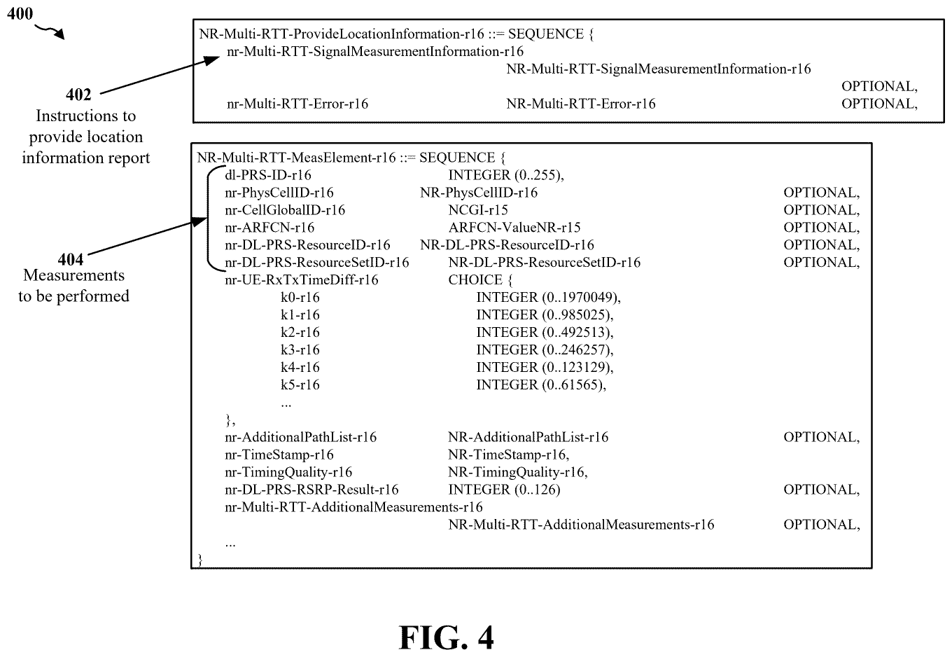

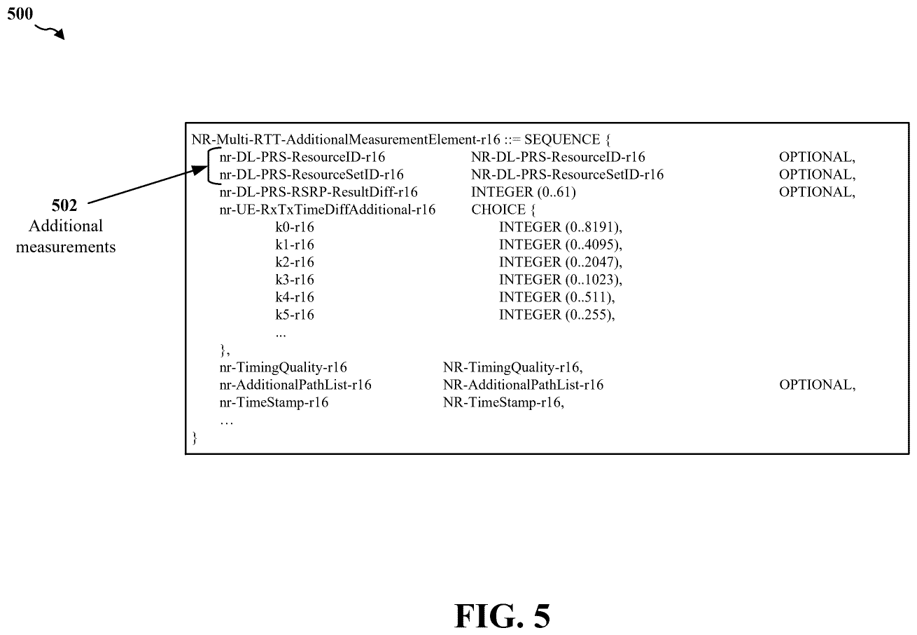

When the UE receives a location request, the UE may perform the measurement of the positioning reference signals and may send a report (e.g., to another entity such as a location server) including the measurement of the positioning reference signals. For example, with reference to diagram 400 of FIG. 4, the UE may receive instructions 402 to provide a location information report. The instructions 402 may further indicate the measurements to be performed (e.g., 404) for the indicated resource identifier. The report may include information related to a time stamp, a timing quality, a downlink positioning reference signals RSRP, or additional measurements. The additional measurements may allow for the UE to include additional information in the report for a given positioning reference signal resource set or resources. In instances of multipath, for a given resource set if the UE detects multipath, there may be multiple measurements, and the UE may report the first multipath in response to the measurements to be performed (e.g., 404), and the UE may report the other paths in the additional measurements, for example as shown in 502 of diagram 500 of FIG. 5. In some instances, the positioning reference signal may be measured multiple times, the best measurement may be included in the report based on the measurements to be performed (e.g., 404), while the other measurements may be included in the report under the additional measurements (e.g., 502). For each positioning reference signal, the UE may add a maximum of three additional measurements. For example, the additional measurements may comprise the 2^{nd}, 3^{rd}, and 4^{th} best TOA based on the measurement results.

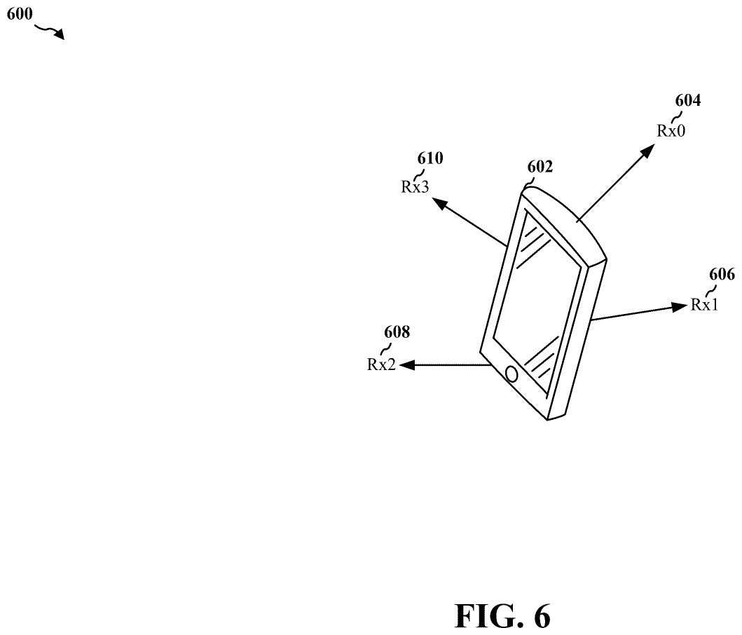

With reference to FIG. 6, the UE 602 may comprise a plurality of receive (Rx) antennas. For example, the UE 602 may comprise Rx0 604, Rx1 606, Rx2 608, and Rx3 610. The UE 602 may utilize the Rx antennas for positioning reference signals. Measurements may occur on multiple antennas to get the benefit of receive diversity. However, the measurement report may be limited to identifying the best receive antenna of the UE. In some instances, the UE may have four measurements for each positioning resource due to the UE having 4 antennas, but the UE report may be limited to only one resource. For example, the report may be based on the best measurement among the four antennas, an average of all the measurements, or a weighted average for all of the antennas.

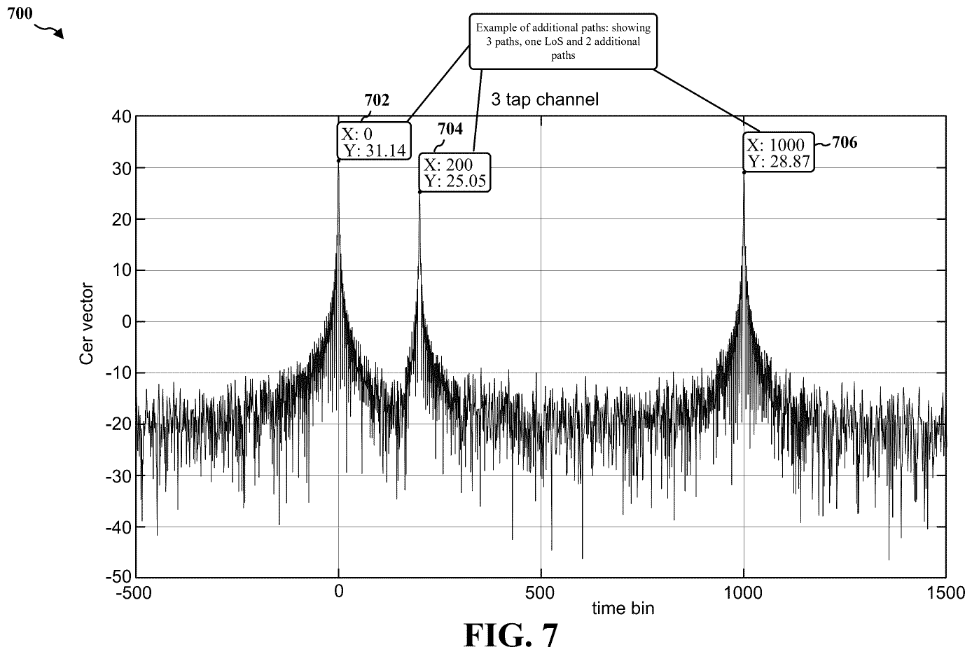

FIG. 7 is a diagram 700 of additional paths of the received positioning reference signals detected by the UE. The diagram 700 includes channel energy response of paths 702, 704, and 706. The path 702 may comprise a line of sight path, while paths 704 and 706 may be additional paths detected by the UE. The paths 704 or 706 may be reflected signals received at the UE where the signal may be reflected by a building, other objects, or terrain, for example. Based on the IFFT size used in the UE, the resolution of the different time bins may be 2, 4, or 8 nanoseconds. With the resolution of the UE time bin as (Tbin), the difference between the additional paths and the line of sight path may be in the order of 10*Tbin, which may be more than 30-40 nanoseconds.

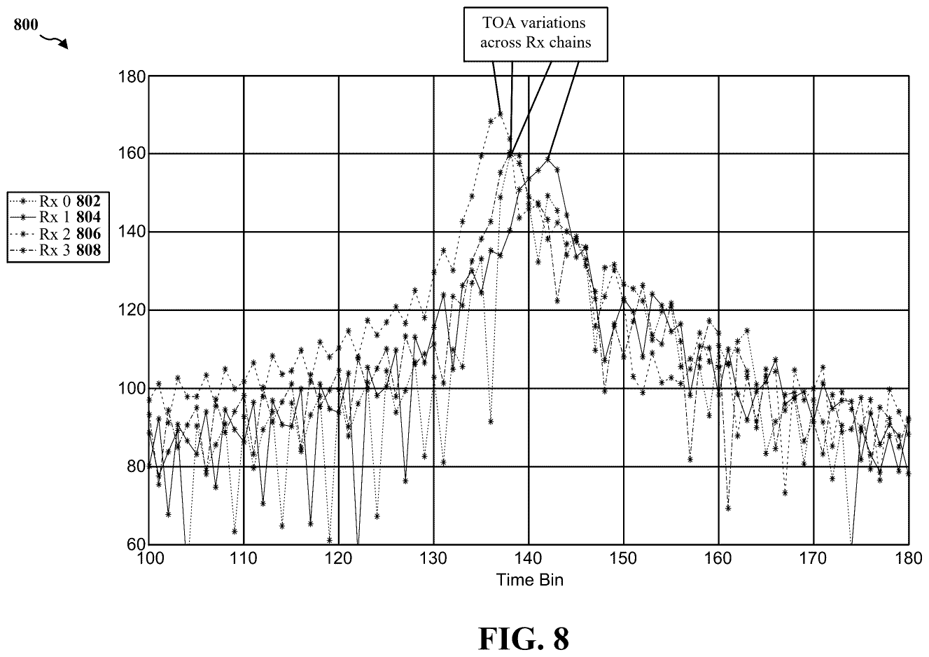

FIG. 8 is a diagram 800 of channel profiles across the different Rx paths. The diagram 800 includes a channel profile for each Rx path (e.g., Rx0 802, Rx1 804, Rx2 806, Rx3 808) of the line of sight path (e.g., 702). The channel profiles are overlapping each other to show the different time arrivals and signal strength of the channel profile of the line of sight path received at each receive antenna of the UE. In some instances, the UE may select the Rx chain for reporting based on time of arrival (TOA) or signal to noise ratio (SNR) of a combination of both. The variation in TOA or SNR may be due to the separation of the receive antennas of the UE. In some instances, the UE may integrate over all the Rx chains to compute a final measurement result. However, the UE report may be limited to one measurement result.

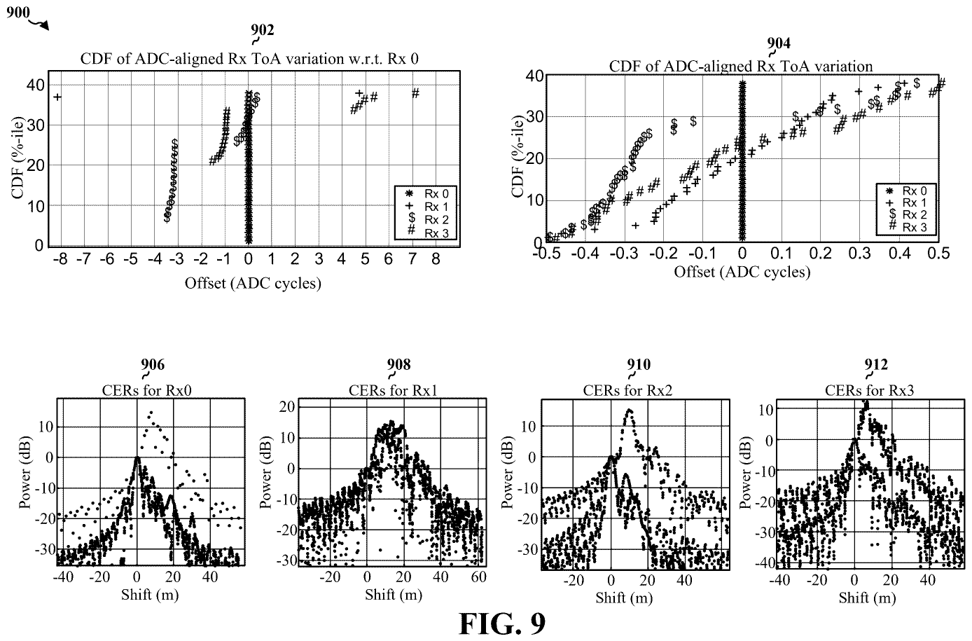

FIG. 9 is a diagram 900 of TOA variations across different Rx chains. The diagram 900 includes a cumulative distribution function (CDF) 902 of TOA variation with respect to Rx0, where Rx0 may comprise the line of sight path. The CDF 902 takes the difference of the channel energy response of Rx0 906 with each of the channel energy responses for the other paths (e.g., Rx1 908, Rx2 910, Rx3 912). The diagram 900 also include a CDF 904 of the Rx TOA variation.

Aspects presented herein provide a configuration for reporting all or multiple receive chain measurements measured by the UE. For example, the UE may be configured to report multiple measurements across multiple receive chains. The multiple measurements may be based on a respective receive antenna of the UE. At least one advantage of reporting all or multiple receive chain measurements is that the server may enhance the computation of the positioning. For example, the LMF may be configured to define its own filter based on each Rx chain and see how the positioning estimates for each Rx is measured, which may allow the network to determine which is the best Rx chain and/or determine how to use the positioning measurements from the different Rx chains. In some instances, the server may maintain a separate filter (e.g., Kalman filter) across different Rx chains.

In some aspects, such as in a line of sight case, there may not be any additional paths available to report. In some aspects, the additional path may be weak in comparison to a strong path (e.g., line of sight path). The additional path may be weaker, by X dB, than the strong path. In some aspects, the additional path may be very far away from an earliest arrival path, such that there is no benefit in the reporting of the additional path measurement. The difference between the additional path and the earliest arrival path (e.g., line of sight path) may be greater than Y seconds. In some aspects, the value of Y may comprise±32 microseconds. In some aspects, the value of Y may comprise±8 microseconds. In some aspects, the UE may be configured to overwrite additional path measurements. For example, the UE may not want to report the additional path measurements and may report the Rx chain measurements.

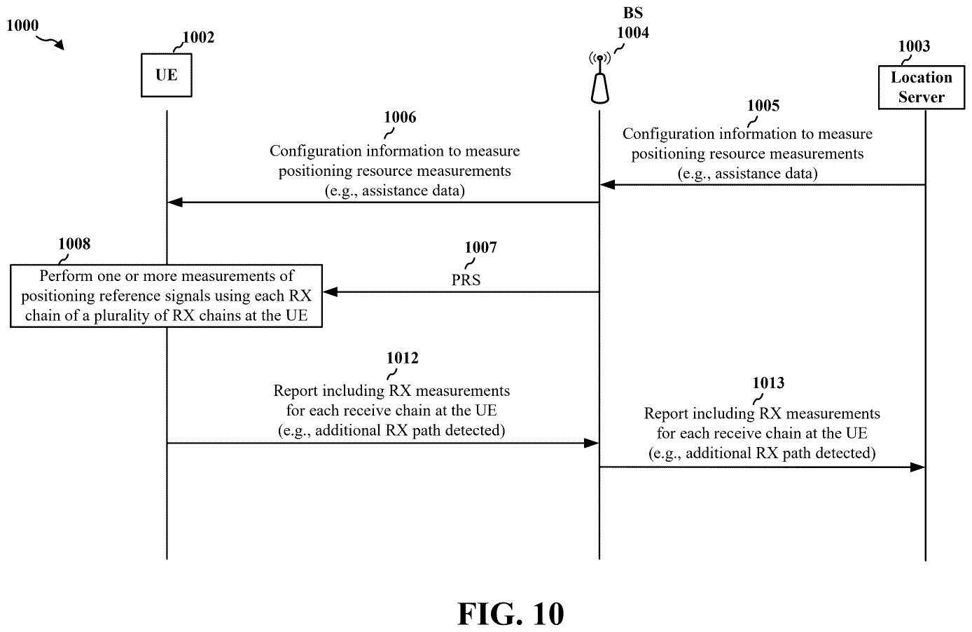

FIG. 10 is a call flow diagram 1000 of signaling between a UE 1002, a base station 1004, and a location server 1005 (e.g., LMF 191). The base station 1004 may be configured to provide at least one cell coverage, for example as shown at coverage area 110 of FIG. 1. The UE 1002 may be configured to communicate with the base station 1004. For example, in the context of FIG. 1, the base station 1004 may correspond to base station 102/180 and, accordingly, the cell may include a geographic coverage area 110 in which communication coverage is provided and/or small cell 102′ having a coverage area 110′. Further, a UE 1002 may correspond to at least UE 104. In another example, in the context of FIG. 3, the base station 1004 may correspond to base station 310 and the UE 1002 may correspond to UE 350.

At 1005, the location server 1003 (e.g., LMF) may provide, to the base station 1004, assistance data including configuration information. The configuration information may include instructions for the UE 1002 to perform one or more measurements of downlink positioning reference signals. The location server 1003 may provide the assistance data including the configuration information to the base station 1004 for transmission to the UE 1002.

At 1006, the UE 1002 may receive assistance data including the configuration information (e.g., PRS configuration) to perform one or more measurements of downlink positioning reference signals. The UE may receive the assistance data including the configuration information to perform one or more measurements of downlink positioning reference signals from the base station 1004. In some aspects, the location server (e.g., LMF) may provide the assistance data including configuration information to the base station for transmission to the UE.

At 1008, the UE 1002 performs the one or more measurements of the downlink positioning reference signals. The UE performs the one or more measurements of the downlink positioning reference signals 1007 received from the base station 1004. The UE may receive the reference signals 1007 one or more base stations, such as but not limited to a serving base station (e.g., base station 1004) and/or neighboring base stations. The UE measures the one or more measurements of the downlink positioning reference signals using each receive chain of a plurality of receive chains at the UE.

At 1012, the UE 1002 transmits a report including RX measurements associated with each receive chain of the plurality of the receive chains at the UE. The UE transmits the report including the RX measurements associated with each receive chain of the plurality of the receive chains at the UE to the base station.

At 1013, the base station 1004 may provide the report including RX measurements associated with each receive chain of the plurality of the receive chains at the UE to the location server 1003. The location server 1003 may utilize the report including the RX measurements associated with each receive chain of the plurality of the receive chains at the UE to determine positioning location of the UE 1002.

In some instances, the UE may indicate within the report that one or more additional RX paths are not present in the measurement of the downlink positioning reference signals. The UE may indicate within the report that the one or more additional RX paths are not present in the measurement of the downlink positioning reference signals in response to a detection that at least one additional RX path is not present in the one or more measurements of the downlink positioning reference signals. In some aspects, the one or more additional RX paths may not be present based on the UE having a strong line of sight connection with at least one of the receive chains of the UE.

The UE may provide the RX measurements associated with each receive chain of the plurality of the receive chains at the UE. The UE may provide the RX measurements associated with each receive chain of the plurality of the receive chains at the UE within a first field associated for reporting the one or more additional RX paths. In some aspects, the report comprising at least the RX measurements of each receive chain of the UE may be included within nr-AdditionalPathList-r16. In some aspects, the first field may comprise nr-AdditionalPathList-r16.

In some instances, the UE may indicate within the report that the one or more additional RX paths are present in the measurement of the downlink positioning reference signals. The UE may indicate within the report that the one or more additional RX paths are present in the measurement of the downlink positioning reference signals in response to a detection that at least one additional RX path is present in the one or more measurements of the downlink positioning reference signals. The one or more additional RX paths may be indicated within a first field associated for reporting the one or more additional RX paths. In some aspects, the first field may comprise nr-AdditionalPathList-r16. In some aspects, the report comprising the one or more additional RX paths may be included within the nr-AdditionalPathList-r16. In some aspects, a signal strength of the at least one additional RX path may be less than a signal strength of a strong RX path, such that the at least one additional RX path having the signal strength that is less than the strong RX path is not reported as a detected additional RX path. In some aspects, the at least one additional RX path may be a far RX path. The far RX path may be based on time in comparison to a strong RX path. For example, a difference between the far RX path and the strong RX path may be greater than Y seconds, where Y>0. The value of Y may be configurable or predetermined. In some aspects, the value of Y may comprise±32 microseconds. In some aspects, the value of Y may comprise±8 microseconds. In some aspects, the at least one additional RX path being the far RX path may not be reported as a detected additional RX path.

The UE may provide the RX measurements associated with each receive chain of the plurality of the receive chains at the UE. The UE may provide the RX measurements associated with each receive chain of the plurality of the receive chains at the UE within a second field. The second field may be associated with the reporting of the RX measurements associated with each receive chain of the plurality of the receive chains at the UE.

In some aspects, the UE may refrain from reporting the at least one additional RX paths as a detected additional RX path. In some aspects, the report may include RX measurements of each receive chain of the UE. The RX measurements of each receive chain of the UE may be based on at least one of TOA, SNR, or a combination thereof. In some aspects, the report comprising the RX measurements of each receive chain of the UE may be included within nr-AdditionalPathList-r16. In some aspects, the UE may detect the presence of the one or more additional RX paths measurements, but may determine to not report the one or more additional RX path measurements. The UE may determine that the inclusion of the one or more additional RX paths measurements may not be beneficial for the location server to calculate the positioning. For example, the RX chain measurements may be higher in quality than that of the one or more additional RX paths, or the one or more additional RX paths measurements may be much lower in quality than that of the RX chain measurements, such that inclusion of the one or more additional RX paths measurements may not add much value. In such instances, the UE may exclude the one or more additional RX paths measurements in an effort to reduce signaling overhead or enhance spectral efficiency.

In some aspects, the UE may overwrite the detection of the at least one additional RX path such that the report comprises the RX measurements of each receive chain of the UE. For example, the UE may determine that the inclusion of the one or more additional RX paths measurements may not be beneficial for the location server to calculate the positioning. For example, the RX chain measurements may be higher in quality than that of the one or more additional RX paths, or the one or more additional RX paths measurements may be much lower in quality than that of the RX chain measurements, such that inclusion of the one or more additional RX paths measurements may not add much value. In such instances, the UE may overwrite the detection of the one or more additional RX paths measurements in an effort to reduce signaling overhead or enhance spectral efficiency. In some aspects, the report comprising the RX measurements of each receive chain of the UE is included within nr-AdditionalPathList-r16.

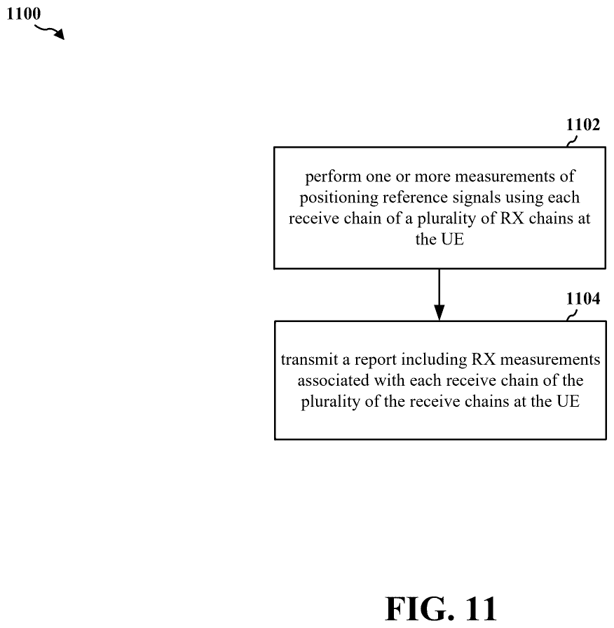

FIG. 11 is a flowchart 1100 of a method of wireless communication. The method may be performed by a UE or a component of a UE (e.g., the UE 104; the apparatus 1302; the cellular baseband processor 1304, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to report multiple measurements across multiple RX chains.

At 1102, the UE performs one or more measurements of positioning reference signals. For example, 1102 may be performed by measurement component 1342 of apparatus 1302. The UE performs the one or more measurements of the positioning reference signals from one or more base stations (e.g., from a serving base station and/or neighboring base stations). The UE measures the one or more measurements of the positioning reference signals using each receive chain of a plurality of receive chains at the UE.

At 1104, the UE transmits a report including RX measurements associated with each receive chain of the plurality of the receive chains at the UE. For example, 1104 may be performed by report component 1344 of apparatus 1302. The UE transmits the report including the RX measurements associated with each receive chain of the plurality of the receive chains at the UE to the base station.

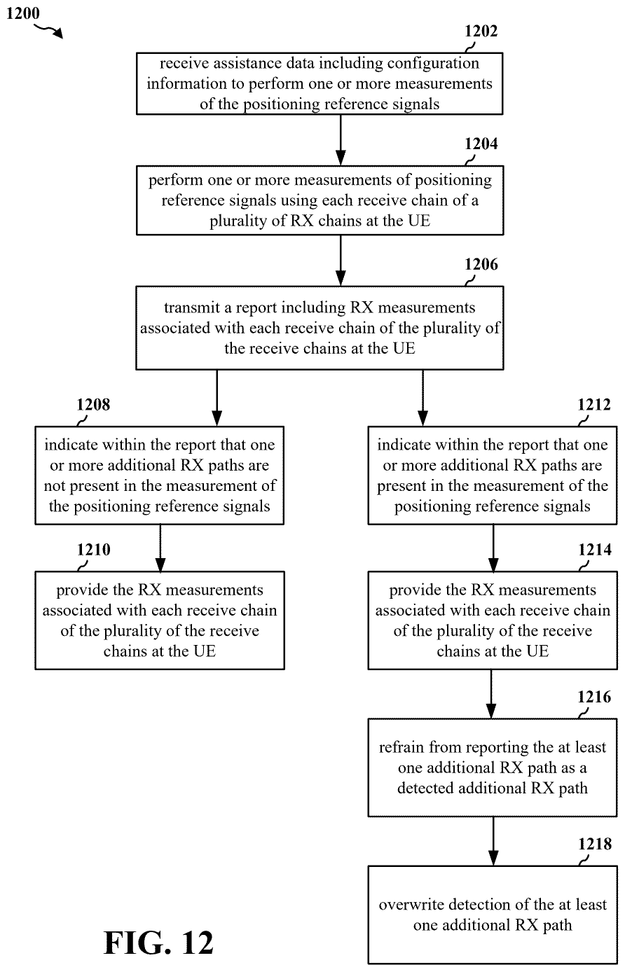

FIG. 12 is a flowchart 1200 of a method of wireless communication. The method may be performed by a UE or a component of a UE (e.g., the UE 104; the apparatus 1302; the cellular baseband processor 1304, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to report multiple measurements across multiple RX chains.

At 1202, the UE may receive assistance data including configuration information to perform one or more measurements of downlink positioning reference signals. For example, 1202 may be performed by configuration component 1340 of apparatus 1302. The UE may receive the assistance data including the configuration information to perform the one or more measurements of positioning reference signals from the base station. In some aspects, a location server (e.g., the LMF) may provide the configuration information to the base station for transmission to the UE.

At 1204, the UE performs one or more measurements of the downlink positioning reference signals. For example, 1204 may be performed by measurement component 1342 of apparatus 1302. The UE performs the one or more measurements of the downlink positioning reference signals received from one or more base stations (e.g., from a serving base station and/or neighboring base stations). The UE measures the one or more measurements of the downlink positioning reference signals using each receive chain of a plurality of receive chains at the UE.

At 1206, the UE transmits a report including RX measurements associated with each receive chain of the plurality of the receive chains at the UE. For example, 1206 may be performed by report component 1344 of apparatus 1302. The UE transmits the report including the RX measurements associated with each receive chain of the plurality of the receive chains at the UE to the base station.

At 1208, the UE may indicate that one or more additional RX paths are not present. For example, 1208 may be performed by report component 1344 of apparatus 1302. The UE may indicate within the report that the one or more additional RX paths are not present in the measurement of the downlink positioning reference signals. The UE may indicate within the report that the one or more additional RX paths are not present in the measurement of the downlink positioning reference signals in response to a detection that at least one additional RX path is not present in the one or more measurements of the downlink positioning reference signals. In some aspects, the one or more additional RX paths may not be present based on the UE having a strong line of sight connection with at least one of the receive chains of the UE.

At 1210, the UE may provide the RX measurements associated with each receive chain of the plurality of the receive chains at the UE. For example, 1210 may be performed by report component 1344 of apparatus 1302. The UE may provide the RX measurements associated with each receive chain of the plurality of the receive chains at the UE within a first field associated for reporting the one or more additional RX paths. In some aspects, the report comprising at least the RX measurements of each receive chain of the UE may be included within nr-AdditionalPathList-r16. In some aspects, the first field may comprise nr-AdditionalPathList-r16.

At 1212, the UE may indicate that one or more additional RX paths are present. For example, 1212 may be performed by report component 1344 of apparatus 1302. The UE may indicate within the report that the one or more additional RX paths are present in the measurement of the downlink positioning reference signals. The UE may indicate within the report that the one or more additional RX paths are present in the measurement of the downlink positioning reference signals in response to a detection that at least one additional RX path is present in the one or more measurements of the downlink positioning reference signals. The one or more additional RX paths may be indicated within a first field associated for reporting the one or more additional RX paths. In some aspects, the first field may comprise nr-AdditionalPathList-r16. In some aspects, the report comprising the one or more additional RX paths may be included within the nr-AdditionalPathList-r16. In some aspects, a signal strength of the at least one additional RX path may be less than a signal strength of a strong RX path, such that the at least one additional RX path having the signal strength that is less than the strong RX path is not reported as a detected additional RX path. In some aspects, the at least one additional RX path may be a far RX path. The far RX path may be based on time in comparison to a strong RX path. For example, a difference between the far RX path and the strong RX path may be greater than Y seconds, where Y>0. The value of Y may be configurable or predetermined. In some aspects, the value of Y may comprise±32 microseconds. In some aspects, the value of Y may comprise±8 microseconds. In some aspects, the at least one additional RX path being the far RX path may not be reported as a detected additional RX path.

At 1214, the UE may provide the RX measurements associated with each receive chain of the plurality of the receive chains at the UE. For example, 1214 may be performed by report component 1344 of apparatus 1302. The UE may provide the RX measurements associated with each receive chain of the plurality of the receive chains at the UE within a second field. The second field may be associated with the reporting of the RX measurements associated with each receive chain of the plurality of the receive chains at the UE.

At 1216, the UE may refrain from reporting the at least one additional RX paths as a detected additional RX path. For example, 1216 may be performed by report component 1344 of apparatus 1302. In some aspects, the report may include RX measurements of each receive chain of the UE. The RX measurements of each receive chain of the UE may be based on at least one of TOA, SNR, or a combination thereof. In some aspects, the report comprising the RX measurements of each receive chain of the UE may be included within nr-AdditionalPathList-r16. In some aspects, the UE may detect the presence of the one or more additional RX paths measurements, but may determine to not report the one or more additional RX path measurements. The UE may determine that the inclusion of the one or more additional RX paths measurements may not be beneficial for the location server to calculate the positioning. For example, the RX chain measurements may be higher in quality than that of the one or more additional RX paths, or the one or more additional RX paths measurements may be much lower in quality than that of the RX chain measurements, such that inclusion of the one or more additional RX paths measurements may not add much value. In such instances, the UE may exclude the one or more additional RX paths measurements in an effort to reduce signaling overhead or enhance spectral efficiency.

At 1218, the UE may overwrite detection of the at least one additional RX path. For example, 1218 may be performed by report component 1344 of apparatus 1302. The UE may overwrite the detection of the at least one additional RX path such that the report comprises the RX measurements of each receive chain of the UE. For example, the UE may determine that the inclusion of the one or more additional RX paths measurements may not be beneficial for the location server to calculate the positioning. For example, the RX chain measurements may be higher in quality than that of the one or more additional RX paths, or the one or more additional RX paths measurements may be much lower in quality than that of the RX chain measurements, such that inclusion of the one or more additional RX paths measurements may not add much value. In such instances, the UE may overwrite the detection of the one or more additional RX paths measurements in an effort to reduce signaling overhead or enhance spectral efficiency. In some aspects, the report comprising the RX measurements of each receive chain of the UE is included within nr-AdditionalPathList-r16.

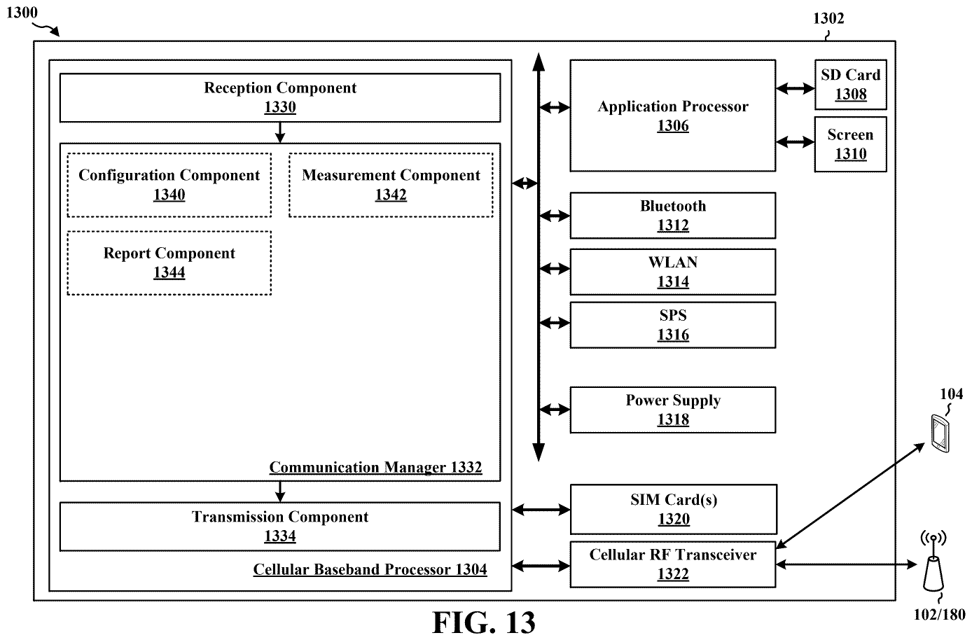

FIG. 13 is a diagram 1300 illustrating an example of a hardware implementation for an apparatus 1302. The apparatus 1302 may be a UE, a component of a UE, or may implement UE functionality. In some aspects, the apparatus 1302 may include a cellular baseband processor 1304 (also referred to as a modem) coupled to a cellular RF transceiver 1322. In some aspects, the apparatus 1302 may further include one or more subscriber identity modules (SIM) cards 1320, an application processor 1306 coupled to a secure digital (SD) card 1308 and a screen 1310, a Bluetooth module 1312, a wireless local area network (WLAN) module 1314, a Satellite Positioning System (SPS) receiver(s) 1316, or a power supply 1318. The SPS module 1316 may comprise SPS or Global Navigation Satellite System (GNSS)—including Global Positioning System (GPS) and other SPS systems such as global navigation satellite system (GLONASS), Beidou, Galileo, or the like. The satellite positioning signals may be GPS signals, GLONASS signals, Galileo signals, Beidou signals, Indian Regional Navigation Satellite System (NAVIC), Quasi-Zenith Satellite System (QZSS), or the like. In instances where the satellite signal receivers include non-terrestrial network (NTN) receivers, the satellite positioning/communication signals may be communication signals (e.g., carrying control and/or user data) originating from a 5G network. The cellular baseband processor 1304 communicates through the cellular RF transceiver 1322 with the UE 104 and/or BS 102/180. The cellular baseband processor 1304 may include a computer-readable medium/memory. The computer-readable medium/memory may be non-transitory. The cellular baseband processor 1304 is responsible for general processing, including the execution of software stored on the computer-readable medium/memory. The software, when executed by the cellular baseband processor 1304, causes the cellular baseband processor 1304 to perform the various functions described supra. The computer-readable medium/memory may also be used for storing data that is manipulated by the cellular baseband processor 1304 when executing software. The cellular baseband processor 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the cellular baseband processor 1304. The cellular baseband processor 1304 may be a component of the UE 350 and may include the memory 360 and/or at least one of the TX processor 368, the RX processor 356, and the controller/processor 359. In one configuration, the apparatus 1302 may be a modem chip and include just the baseband processor 1304, and in another configuration, the apparatus 1302 may be the entire UE (e.g., see 350 of FIG. 3) and include the additional modules of the apparatus 1302.

The communication manager 1332 includes a configuration component 1340 that is configured to receive assistance data including configuration information to perform one or more measurements of positioning reference signals, e.g., as described in connection with 1202 of FIG. 12. The communication manager 1332 further includes a measurement component 1342 that is configured to perform one or more measurements of positioning reference signals, e.g., as described in connection with 1102 of FIG. 11 or 1204 of FIG. 12. The communication manager 1332 further includes a report component 1344 that is configured to transmit a report including RX measurements associated with each receive chain of the plurality of the receive chains at the UE, e.g., as described in connection with 1104 of FIG. 11 of 1206 of FIG. 12. The report component 1344 may be further configured to indicate that one or more additional RX paths are not present, e.g., as described in connection with 1208 of FIG. 12. The report component 1344 may be further configured to provide the RX measurements associated with each receive chain of the plurality of the receive chains at the UE, e.g., as described in connection with 1210 of FIG. 12. The report component 1344 may be further configured to indicate that one or more additional RX paths are present, e.g., as described in connection with 1212 of FIG. 12. The report component 1344 may be further configured to provide the RX measurements associated with each receive chain of the plurality of the receive chains at the UE, e.g., as described in connection with 1214 of FIG. 12. the report component 1344 may be further configured to refrain from reporting the at least one additional RX paths as a detected additional RX path, e.g., as described in connection with 1216 of FIG. 12. The report component 1344 may be further configured to overwrite detection of the at least one additional RX path, e.g., as described in connection with 1218 of FIG. 12.

The apparatus may include additional components that perform each of the blocks of the algorithm in the flowcharts of FIGS. 11 and 12. As such, each block in the flowcharts of FIGS. 11 and 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the cellular baseband processor 1304, includes means for performing one or more measurements of positioning reference signals using each receive chain of a plurality of receive chains at the UE. The apparatus includes means for transmitting a report including RX measurements associated with each receive chain of the plurality of the receive chains at the UE. The apparatus includes means for indicating within the report that one or more additional RX paths are not present in the measurement of the positioning reference signals. The apparatus further includes means for providing the RX measurements associated with each receive chain of the plurality of the receive chains at the UE within a first field associated for reporting the one or more additional RX paths. The apparatus further includes means for indicating within the report that one or more additional RX paths are present in the measurement of the positioning reference signals, wherein the one or more additional RX paths are indicated within a first field associated for reporting the one or more additional RX paths. The apparatus further includes means for providing the RX measurements associated with each receive chain of the plurality of the receive chains at the UE within a second field associated for reporting the RX measurements associated with each receive chain of the plurality of the receive chains at the UE. The apparatus further includes means for refraining from reporting the at least one additional RX path as a detected additional RX path. The apparatus further includes means for receiving assistance data including configuration information to perform one or more measurements of positioning reference signals. The apparatus further includes means for overwriting detection of the at least one additional RX path, wherein the report comprises the RX measurements of each receive chain of the UE. The means may be one or more of the components of the apparatus 1302 configured to perform the functions recited by the means. As described supra, the apparatus 1302 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and at least one transceiver and configured to perform one or more measurements of positioning reference signals using each receive chain of a plurality of RX chains at the UE; and transmit a report including RX measurements associated with each receive chain of the plurality of the receive chains at the UE.

Aspect 2 is the apparatus of aspect 1, further includes that in response to a detection that at least one additional RX path is not present in the one or more measurements of the positioning reference signals, the at least one processor is further configured to indicate within the report that one or more additional RX paths are not present in the measurement of the positioning reference signals; and provide the RX measurements associated with each receive chain of the plurality of the receive chains at the UE within a first field associated for reporting the one or more additional RX paths.

Aspect 3 is the apparatus of any of aspects 1 and 2, further includes that the one or more additional RX paths are not present based on the UE having a strong line of sight connection.

Aspect 4 is the apparatus of any of aspects 1-3, further includes that the report comprising at least the RX measurements of each receive chain of the UE is included within nr-AdditionalPathList-r16, wherein the first field comprises the nr-AdditionalPathList-r16.

Aspect 5 is the apparatus of any of aspects 1-4, further includes that in response to a detection that at least one additional RX path is present in the one or more measurements of the positioning reference signals, the at least one processor is further configured to indicate within the report that one or more additional RX paths are present in the measurement of the positioning reference signals, wherein the one or more additional RX paths are indicated within a first field associated for reporting the one or more additional RX paths; and provide the RX measurements associated with each receive chain of the plurality of the receive chains at the UE within a second field associated for reporting the RX measurements associated with each receive chain of the plurality of the receive chains at the UE.

Aspect 6 is the apparatus of any of aspects 1-5, further includes that the first field comprises nr-AdditionalPathList-r16, wherein the report comprising the one or more additional RX paths is included within the nr-AdditionalPathList-r16.

Aspect 7 is the apparatus of any of aspects 1-6, further includes that a signal strength of the at least one additional RX path is less than a signal strength of a strong RX path, wherein the at least one additional RX path having the signal strength less than the strong RX path is not reported as a detected additional RX path.

Aspect 8 is the apparatus of any of aspects 1-7, further includes that the at least one additional RX path is a far RX path based on time in comparison to a strong RX path, wherein the at least one additional RX path being the far RX path is not reported as a detected additional RX path.

Aspect 9 is the apparatus of any of aspects 1-8, further includes that a difference between the far RX path and the strong RX path is greater than Y seconds.

Aspect 10 is the apparatus of any of aspects 1-9, further includes that the at least one processor is further configured to refrain from reporting the at least one additional RX path as a detected additional RX path.

Aspect 11 is the apparatus of any of aspects 1-10, further includes that the report includes RX measurements of each receive chain of the UE, wherein the RX measurements of each receive chain of the UE are based on at least one of time of arrival (TOA), signal to noise ratio (SNR), or a combination thereof.

Aspect 12 is the apparatus of any of aspects 1-11, further includes that the report comprising the RX measurements of each receive chain of the UE is included within nr-AdditionalPathList-r16.

Aspect 13 is the apparatus of any of aspects 1-12, further includes that the at least one processor is further configured to overwrite detection of the at least one additional RX path, wherein the report comprises the RX measurements of each receive chain of the UE.

Aspect 14 is the apparatus of any of aspects 1-13, further includes that the report comprising the RX measurements of each receive chain of the UE is included within nr-AdditionalPathList-r16.

Aspect 15 is the apparatus of any of aspects 1-14, further includes that the at least one processor is further configured to receive assistance data including configuration information to perform one or more measurements of the positioning reference signals.

Aspect 16 is a method of wireless communication for implementing any of aspects 1-15.

Aspect 17 is an apparatus for wireless communication including means for implementing any of aspects 1-15.

Aspect 18 is a computer-readable medium storing computer executable code, where the code when executed by a processor causes the processor to implement any of aspects 1-15.

1. An apparatus for wireless communication at a user equipment (UE), comprising:
a memory;
at least one transceiver; and
at least one processor, communicatively connected to the memory and the at least one transceiver, the at least one processor configured to:
perform one or more measurements of positioning reference signals using each receive chain of a plurality of receive (RX) chains at the UE; and
transmit a report including RX measurements associated with each receive chain of the plurality of the receive chains at the UE.

2. The apparatus of claim 1, wherein, in response to a detection that at least one additional RX path is not present in the one or more measurements of the positioning reference signals, the at least one processor is further configured to:
indicate within the report that one or more additional RX paths are not present in the measurement of the positioning reference signals; and
provide the RX measurements associated with each receive chain of the plurality of the receive chains at the UE within a first field associated for reporting the one or more additional RX paths.

3. The apparatus of claim 2, wherein the one or more additional RX paths are not present based on the UE having a strong line of sight connection.

4. The apparatus of claim 2, wherein the report comprising at least the RX measurements of each receive chain of the UE is included within nr-AdditionalPathList-r16, wherein the first field comprises the nr-AdditionalPathList-r16.

5. The apparatus of claim 1, wherein, in response to a detection that at least one additional RX path is present in the one or more measurements of the positioning reference signals, the at least one processor is further configured to:
indicate within the report that one or more additional RX paths are present in the measurement of the positioning reference signals, wherein the one or more additional RX paths are indicated within a first field associated for reporting the one or more additional RX paths; and
provide the RX measurements associated with each receive chain of the plurality of the receive chains at the UE within a second field associated for reporting the RX measurements associated with each receive chain of the plurality of the receive chains at the UE.

6. The apparatus of claim 5, wherein the first field comprises nr-AdditionalPathList-r16, wherein the report comprising the one or more additional RX paths is included within the nr-AdditionalPathList-r16.

7. The apparatus of claim 5, wherein a signal strength of the at least one additional RX path is less than a signal strength of a strong RX path, wherein the at least one additional RX path having the signal strength less than the strong RX path is not reported as a detected additional RX path.

8. The apparatus of claim 5, wherein the at least one additional RX path is a far RX path based on time in comparison to a strong RX path, wherein the at least one additional RX path being the far RX path is not reported as a detected additional RX path.

9. The apparatus of claim 8, wherein a difference between the far RX path and the strong RX path is greater than Y seconds.

10. The apparatus of claim 5, wherein the at least one processor is further configured to:
refrain from reporting the at least one additional RX path as a detected additional RX path.

11. The apparatus of claim 10, wherein the report includes RX measurements of each receive chain of the UE, wherein the RX measurements of each receive chain of the UE are based on at least one of time of arrival (TOA), signal to noise ratio (SNR), or a combination thereof.

12. The apparatus of claim 10, wherein the report comprising the RX measurements of each receive chain of the UE is included within nr-AdditionalPathList-r16.

13. The apparatus of claim 5, wherein the at least one processor is further configured to:
overwrite detection of the at least one additional RX path, wherein the report comprises the RX measurements of each receive chain of the UE.

14. The apparatus of claim 13, wherein the report comprising the RX measurements of each receive chain of the UE is included within nr-AdditionalPathList-r16.

15. The apparatus of claim 1, wherein the at least one processor is further configured to:
receive assistance data including configuration information to perform one or more measurements of the positioning reference signals.

16. A method of wireless communication at a user equipment (UE), comprising:
performing one or more measurements of positioning reference signals using each receive (RX) chain of a plurality of receive chains at the UE; and
transmitting a report including RX measurements associated with each receive chain of the plurality of the receive chains at the UE.

17. The method of claim 16, wherein, in response to a detection that at least one additional RX path is not present in the one or more measurements of the positioning reference signals, further comprising:
indicating within the report that one or more additional RX paths are not present in the measurement of the positioning reference signals; and
providing the RX measurements associated with each receive chain of the plurality of the receive chains at the UE within a first field associated for reporting the one or more additional RX paths.

18. The method of claim 17, wherein the one or more additional RX paths are not present based on the UE having a strong line of sight connection.

19. The method of claim 17, wherein the report comprising at least the RX measurements of each receive chain of the UE is included within nr-AdditionalPathList-r16, wherein the first field comprises the nr-AdditionalPathList-r16.

20. The method of claim 16, wherein, in response to a detection that at least one additional RX path is present in the one or more measurements of the positioning reference signals, further comprising:
indicating within the report that one or more additional RX paths are present in the measurement of the positioning reference signals, wherein the one or more additional RX paths are indicated within a first field associated for reporting the one or more additional RX paths; and
providing the RX measurements associated with each receive chain of the plurality of the receive chains at the UE within a second field associated for reporting the RX measurements associated with each receive chain of the plurality of the receive chains at the UE.

21. The method of claim 20, wherein the first field comprises nr-AdditionalPathList-r16, wherein the report comprising the one or more additional RX paths is included within the nr-AdditionalPathList-r16.

22. The method of claim 20, wherein a signal strength of the at least one additional RX path is less than a signal strength of a strong RX path, wherein the at least one additional RX path having the signal strength less than the strong RX path is not reported as a detected additional RX path.

23. The method of claim 20, wherein the at least one additional RX path is a far RX path based on time in comparison to a strong RX path, wherein the at least one additional RX path being the far RX path is not reported as a detected additional RX path, wherein a difference between the far RX path and the strong RX path is greater than Y seconds.

24. The method of claim 20, further comprising:
refraining from reporting the at least one additional RX path as a detected additional RX path.

25. The method of claim 24, wherein the report includes RX measurements of each receive chain of the UE, wherein the RX measurements of each receive chain of the UE are based on at least one of time of arrival (TOA), signal to noise ratio (SNR), or a combination thereof.

26. The method of claim 24, wherein the report comprising the RX measurements of each receive chain of the UE is included within nr-AdditionalPathList-r16.

27. The method of claim 20, further comprising:
overwriting detection of the at least one additional RX path, wherein the report comprises the RX measurements of each receive chain of the UE, wherein the report comprising the RX measurements of each receive chain of the UE is included within nr-AdditionalPathList-r16.

28. The method of claim 16, further comprising:
receiving assistance data including configuration information to perform one or more measurements of the positioning reference signals.

29. An apparatus for wireless communication at a user equipment (UE), comprising:
means for performing one or more measurements of positioning reference signals using each receive chain of a plurality of receive (RX) chains at the UE; and
means for transmitting a report including RX measurements associated with each receive chain of the plurality of the receive chains at the UE.

30. A computer-readable medium storing computer executable code at user equipment (UE), the code when executed by a processor causes the processor to:
perform one or more measurements of positioning reference signals using each receive chain of a plurality of receive (RX) chains at the UE; and
transmit a report including RX measurements associated with each receive chain of the plurality of the receive chains at the UE.
